(19) United States
(12) Patent Application Publication
(10) Pub. No.: US 2019/0309583 A1
(43) Pub. Date: Oct. 10, 2019

(54) Direct Drive Systems

(71) Applicant: Cameron International Corporation, Houston, TX (US)

(72) Inventor: Michael Netecke, Houston, TX (US)

(21) Appl. No.: 15/950,138

(22) Filed: Apr. 10, 2018

(51) Int. Cl. E21B 19/00; E21B 21/00; B66D 5/14; B66D 1/12; F04B 9/02; H02P 5/74; H02P 3/04

(52) U.S. Cl. CPC E21B 19/008; E21B 21/00; B66D 5/14; B66D 1/12; B66D 2700/07; H02P 5/74; H02P 3/04; B66D 2700/025; F04B 9/02

(57) ABSTRACT

A system for a mineral extraction system includes a shaft rotatably supported on a platform, a first motor having a first output shaft that is coupled to a first end portion of the shaft to drive rotation of the shaft, and a second motor having a second output shaft that is coupled to a second end portion of the shaft to drive rotation of the shaft. The system is devoid of a transmission between the first motor and the shaft.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Natural resources, such as oil and gas, are used as fuel to power vehicles, heat homes, and generate electricity, in addition to various other uses. Once a desired resource is discovered below the surface of the earth, drilling and production systems are often employed to access and extract the resource. These systems may be located onshore or offshore depending on the location of the desired resource. Further, such systems may include a wide variety of components, such as various casings, fluid conduits, tools, and the like, that facilitate extraction of the resource from a well during drilling or extraction operations. In some systems, a drawworks system (e.g., hoisting or lifting assembly) is provided to raise and/or to lower certain components relative to the well. However, some drawworks systems may be large and/or complex.

Furthermore, some drawworks systems may be difficult to maintain and/or repair, thereby resulting in increased downtime during maintenance and/or repair operations, and/or resulting in inefficient drilling operations.

### BRIEF DESCRIPTION OF THE DRAWINGS

Various features, aspects, and advantages of the present disclosure will become better understood when the following detailed description is read with reference to the accompanying figures in which like characters represent like parts throughout the figures, wherein:

FIG. 1 is a schematic diagram of a portion of a drilling and production system, in accordance with an embodiment of the present disclosure;

FIG. 2 is a perspective front view of a drawworks system that may be used in the drilling and production system of FIG. 1, in accordance with an embodiment of the present disclosure;

FIG. 3 is a perspective rear view of the drawworks system of FIG. 2, in accordance with an embodiment of the present disclosure;

FIG. 4 is a cross-sectional front view of the drawworks system of FIG. 2, in accordance with an embodiment of the present disclosure;

FIG. 5 is a cross-sectional top view of the drawworks system of FIG. 2, in accordance with an embodiment of the present disclosure;

FIG. 6 is a schematic diagram of a control system that may be used in the drilling and production system of FIG. 1, in accordance with an embodiment of the present disclosure;

FIG. 7 is a perspective front view of a drawworks system having one motor assembly that may be used in the drilling and production system of FIG. 1, in accordance with an embodiment of the present disclosure;

FIG. 8 is a perspective front view of a pump system that may be used in the drilling and production system of FIG. 1, in accordance with an embodiment of the present disclosure; and

FIG. 9 is a perspective rear view of the pump system of FIG. 8, in accordance with an embodiment of the present disclosure;

FIG. 10 is a side view of the pump system of FIG. 8, in accordance with an embodiment of the present disclosure;

FIG. 11 is a cross-sectional front view of the pump system of FIG. 8, in accordance with an embodiment of the present disclosure;

FIG. 12 is a perspective front view of another drawworks system that may be used in the drilling and production system of FIG. 1, in accordance with an embodiment of the present disclosure;

FIG. 13 is a perspective rear view of the drawworks system of FIG. 12, in accordance with an embodiment of the present disclosure;

FIG. 14 is a cross-sectional front view of the drawworks system of FIG. 12, in accordance with an embodiment of the present disclosure;

FIG. 15 is a cross-sectional top view of the drawworks system of FIG. 12, in accordance with an embodiment of the present disclosure;

FIG. 16 is a front view of the drawworks system of FIG. 12, in accordance with an embodiment of the present disclosure; and

FIG. 17 is an exploded perspective front view of the drawworks system of FIG. 12, in accordance with an embodiment of the present disclosure.

### DETAILED DESCRIPTION OF SPECIFIC EMBODIMENTS

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present embodiments are generally directed to drawworks systems and methods (e.g., hoisting or lifting systems and methods) for use within a drilling and production system. Certain embodiments include a drawworks system having one or more motors, one or more brakes, and a drum (e.g., annular drum) mounted on a drum shaft. The drum is configured to support a cable (e.g., wire) that is coupled to components of a hoisting system from which drilling equipment, such as a drill string, is suspended. Rotation of the drum causes the cable to retract (e.g., wrap or wind about the drum) and/or to extend (e.g., unwrap or unwind from the drum) to raise and/or to lower the drilling equipment relative to a drill floor. For example, rotation of the drum in a first direction may cause the cable to extend to lower the drill string to facilitate drilling a wellbore through subterranean formations. In certain embodiments, the drum shaft may be coupled (e.g., directly coupled) to one or more output shafts of the one or more motors to enable the one or more motors to drive rotation of the drum. The disclosed embodiments may provide a compact drawworks system and/or may facilitate maintenance and/or repair of the components of the drawworks system, for example. It should be appreciated that various the drive system (e.g., arrangement of the one or more motors, one or more brakes, and/or other associated components) that is used as part of the drawworks system disclosed herein may be adapted for use with various other types of equipment, such as a pump system that pumps drilling fluid through the drill string to a drill bit as the drill bit drills the wellbore.

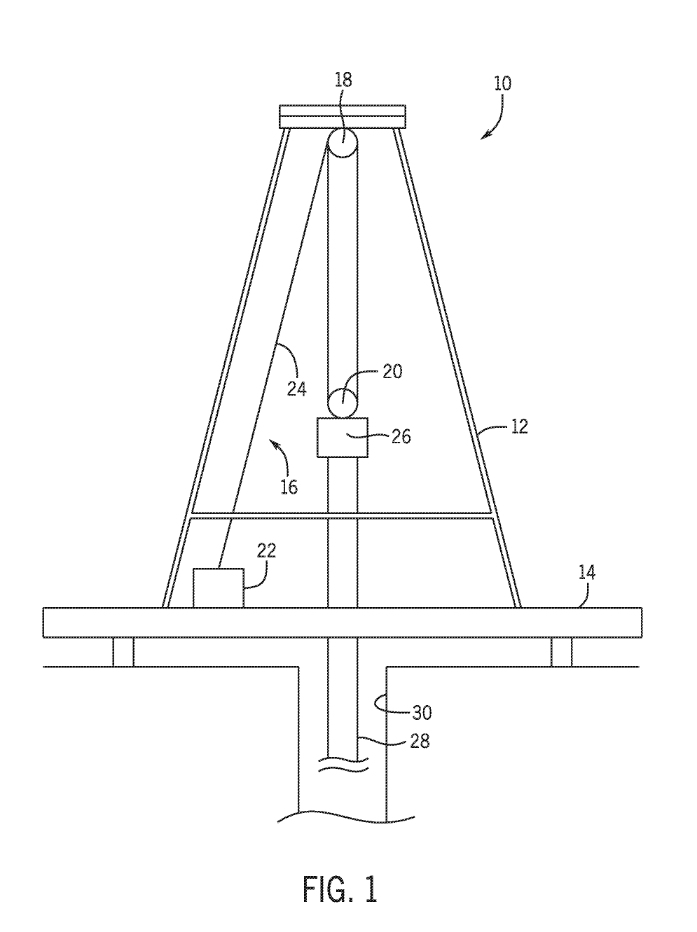

With the foregoing in mind, FIG. 1 is a schematic diagram of a portion of a drilling and production system 10, in accordance with an embodiment of the present disclosure. As shown, the system 10 includes a mast 12 positioned on a drill floor 14 and a hoisting system 16 configured to raise and to lower drilling equipment relative to the drill floor 14. In the illustrated embodiment, the hoisting system 16 includes a crown block 18, a traveling block 20, and a drawworks system 22. As shown, a cable 24 (e.g., wire) extends from the drawworks system 22 and couples the crown block 18 to the traveling block 20. In the illustrated embodiment, a top drive 26 is coupled to the traveling block 20, and a drill string 28 is suspended from the top drive 26 and extends through the drill floor 14 into a wellbore 30. The top drive 26 may be configured to rotate the drill string 28, and the hoisting system 16 may be configured to raise and to lower the top drive 26 and the drill string 28 relative to the drill floor 14 to facilitate drilling of the wellbore 30.

Any suitable number of lines of the cable 24 may extend between the crown block 18 and the traveling block 20, and the cable 24 may have any suitable diameter, such as a diameter in a range of 1 to 7 centimeters (cm) or a diameter between approximately 3 to 5, 4 to 4.75, or 4.25 to 4.5 cm. While FIG. 1 illustrates a land-based drilling and production system 10 to facilitate discussion, it should be understood that the disclosed embodiments may be adapted for use within an offshore drilling and production system. Furthermore, it should be understood that the disclosed drawworks system 22 may be utilized in any of a variety of drilling and production systems.

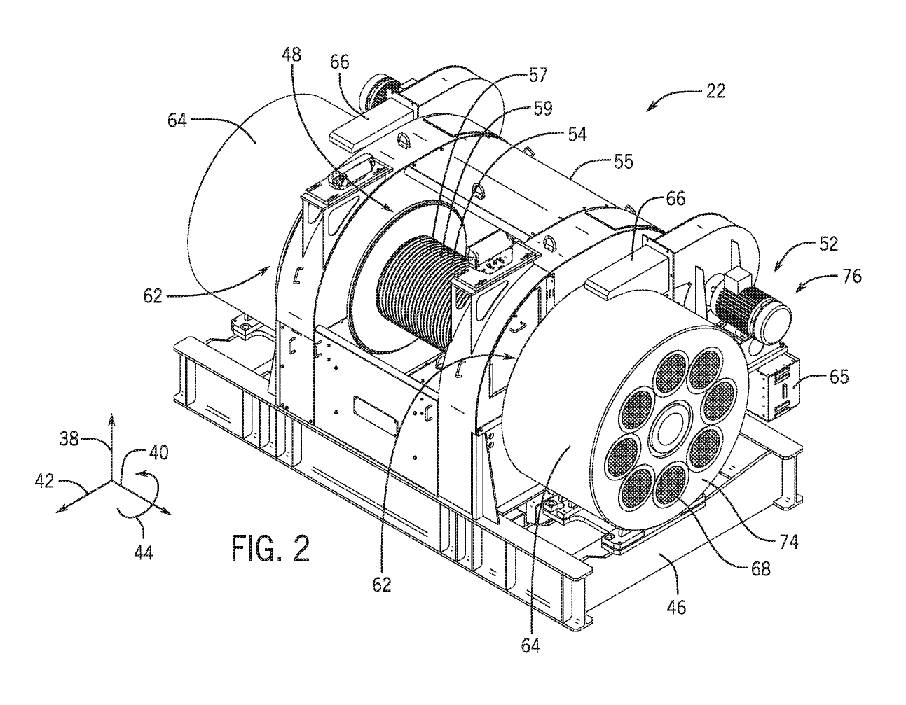

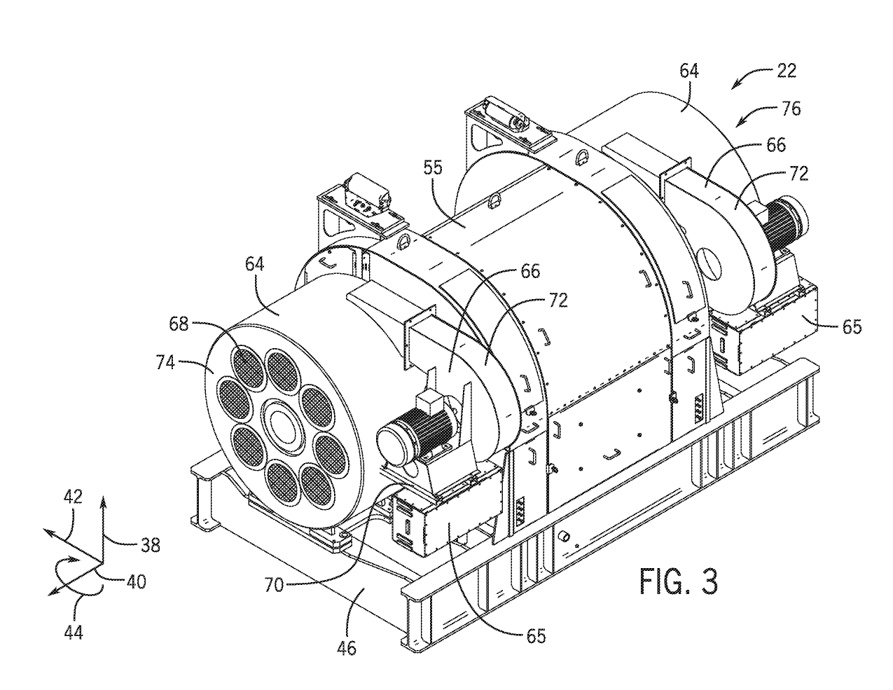

FIG. 2 is a perspective front view and FIG. 3 is a perspective rear view of an embodiment of the drawworks system 22 that may be used in the drilling and production system 10 of FIG. 1. To facilitate discussion, the drawworks system 22 and its components may be described with reference to a vertical axis or direction 38, an axial axis or direction 40, a lateral axis or direction 42 (or a radial axis or direction), and a circumferential axis or direction 44. In the illustrated embodiment, the drawworks system 22 includes a skid 46 (e.g., frame or support structure) that supports a drum assembly 48 and a motor assembly 52.

The drum assembly 48 may include a drum 54 (e.g., annular drum) mounted on a drum shaft and positioned within or at least partially covered by a drum housing 55. As shown, an outer surface 57 (e.g., annular surface) of the drum 54 includes grooves 59 (e.g., circumferentially-extending grooves or Lebus grooves) that are configured to support a cable (e.g., the cable 24) that is wrapped circumferentially about the drum 54. In some embodiments, the drum 54 may have a diameter in a range of 90 to 150 centimeters (cm). In some embodiments, the drum 54 may have a diameter of between approximately 110 and 130, 115 and 125, or 118 and 120 cm.

The motor assembly 52 may include one or more electric motors 62 (e.g., pseudo direct drive [PDD] motors manufactured by Magnomatics, alternating current [AC] motors, permanent magnet [PM] motors) supported within respective motor housings 64. The motor housings 64 may be coupled to the drum housing 55 via one or more fasteners (e.g., bolts). The motor assembly 52 may also include one or more junction boxes 65 that support circuitry to power or control operation of the one or more motors 62, one or more air intake assemblies 66 that provide air to the one or more motors 62, and one or more exhaust ports 68 that exhaust air from the one or more motors 62. More particularly, each motor 62 may be coupled to a respective junction box 65 that includes circuitry to power or control operation of the motor 62. Furthermore, each motor 62 may be coupled to a respective air intake assembly 66 of the one or more air intake assemblies 66, and each of the one or more air intake assemblies 66 may include an inlet 70 and a fan 72 (e.g., blower) configured to draw air through the inlet 70 and force air into the motor 62. Each motor 62 may also include one or more exhaust ports 68, which may be formed in the motor housing 64. As shown, multiple exhaust ports 68 are arranged circumferentially about an axially-facing end surface 74 of the motor housing 64. The illustrated position of the exhaust ports 68 and the air intake assembly 68 may facilitate cooling (e.g., the hot air exhausted through the exhaust ports 68 may be directed generally away from the air inlet 70).

The illustrated embodiment includes two motors 62; however, it should be understood that any suitable number (e.g., 1, 2, 3, 4, or more) of motors 62 may be provided. As discussed in more detail below, respective output shafts extending from the one or more motors 62 of the motor assembly 52 may be coupled (e.g., directly coupled via a splined interface, shrink disc coupling, key-slot interface, bushings, stub shaft, one-piece adapter) to respective ends of the drive shaft of the drum assembly 48.

In certain embodiments (e.g., embodiments having two motors 62), each of the motors 62 may be configured to operate continuously at least equal to or greater than approximately 1100 horsepower (HP), and each of the motors 62 may be configured to operate intermittently at least equal to or greater than approximately 1600 HP (e.g., during hoisting operations or over a limited period of time, such as less than 10, 20, 30, 60, 90, 120, 180, or 300 minutes). Thus, during hoisting operations, the two motors 62 shown in FIG. 2 may together provide a total of at least equal to or greater than approximately 3200 HP. In some embodiments, each of the motors 62 may be configured to operate continuously between approximately 800-1800, 1000-1500, or 1100-1200 HP and/or intermittently between approximately 1200-2000, 1400-1800, or 1500-1600 HP. In certain embodiments (e.g., embodiments having one motor 62), the motor 62 may be configured to operate continuously at least equal to or greater than approximately 2200 HP.

In embodiment having multiple motors 62, the multiple motors 62 may enable the drawworks system 22 to hoist the load using less than all of the motors 62 (e.g., upon failure of one of the two motors 62 shown in FIG. 2). For example, during normal operation of the drawworks system 22, both of the motors 62 may drive rotation of the drum 54 to move a load. However, upon certain circumstances (e.g., if a first motor 62 fails), one motor 62 (e.g., the first motor 62) may be disconnected from the drum shaft of the drum 52 and another motor 62 (e.g., a second motor 62) may operate to enable the drawworks system 22 to lift the load using only the second motor 62.

The components of the drawworks system 22 are arranged in a configuration that is compact and that may also facilitate maintenance operations. For example, as shown, the motor assemblies 62 are positioned on opposite sides of the drum assembly 58 along the axial axis 40 (e.g., the drum assembly 58 is positioned between the two motor assemblies 62 along the axial axis 40). Furthermore, each air inlet 70 of the respective air inlet assembly 66 is positioned rearward of the respective motor housing 64 along the radial axis 42, and each junction box 65 is positioned rearward of the respective motor housing 64 along the radial axis 42 and also below the air inlet 70 and the fan 72 of the respective air inlet assembly 66 along the vertical axis 38. In the illustrated embodiment, the exhaust ports 68 are formed in the axially-facing end surface 74 of the motor housing 64. Thus, for each motor 62, the drum 54 is positioned one side of the motor 62, and the exhaust ports 68 are positioned on an opposite side of the motor 62 along the axial axis 40 (e.g., the motor 62 is positioned between the drum 54 and the exhaust ports 68 formed in the axially-facing end surface 74 of the motor housing 64 along the axial axis 40). Furthermore, in the illustrated embodiment, each junction box 65 and each air intake assembly 66 do not extend beyond the respective motor housing 64 along the axial axis 40 (e.g., an entirety of the junction box 65 and an entirety of the air intake assembly 66 are positioned between the drum housing 55 and the axially-facing end surface 74 of the respective motor housing 64 along the axial axis 40). Each air intake assembly 66 may also be positioned so as not to extend above the respective motor housing 64 along the vertical axis 38 (e.g., relative to the rig floor).

As discussed in more detail below, the drawworks system 22 includes a brake assembly and may further include or be coupled to a control system (e.g., an electronic control system having an electronic controller having a processor and a memory) that is configured to receive and to process data from various sensors positioned about the drawworks system 22 (e.g., a temperature sensor coupled to a brake, a speed sensor coupled to the motor 62, a speed sensor coupled to the drum shaft), to receive control signals and/or operator inputs, to provide an indication (e.g., a visual indication via a display and/or an audible indication via a speaker) of a condition of the drawworks system 22 (e.g., failure of the motor 62) to an operator, and/or to control components of the drawworks system 22 (e.g., move the brake between a braked position and a non-braked position, operate the one or more motors 62) based on the data and/or the operator inputs, for example. In certain embodiments, the drawworks system 22 disclosed herein may utilize gaseous fluid (e.g., air or inert gas, such as nitrogen) in operation (e.g., to cool the motors 62, to operate the brake), and may not utilize liquid fluid (e.g., water) in operation. It should be appreciated that the motor assembly 52, the brake assembly, and the control system may form a drive system 76 that is configured to drive and to block rotation of the drum 54.

Advantageously, the disclosed drawworks system 22 may be devoid of a transmission (e.g., gearbox having mechanical gears, such as spur gears or the like). For example, the drawworks system 22 does not include a transmission between the one or more motors 62 and the drum shaft 80 to adjust a power output of the one or more motors 62 to drive the drum shaft 80. Thus, the drawworks system 22 does not adjust the power output of the one or more motors 62 to drive the drum shaft 80, and the drawworks system 22 does not utilize pressurized oil for lubrication of gears, bearings, or the like. Thus, the drawworks system 22 includes a relatively low number of components (e.g., compared to other drawworks systems), which may reduce cost, size, weight, and/or facilitate maintenance operations. Furthermore, the drawworks system 22 is a low-inertia system, and thus, the drawworks system 22 may utilize less energy during hoisting, lowering, and braking operations. The low inertia may also provide faster tripping (e.g., hoisting and lowering) times due to quicker acceleration and more time at peak block speed (e.g., speed of the traveling block 20).

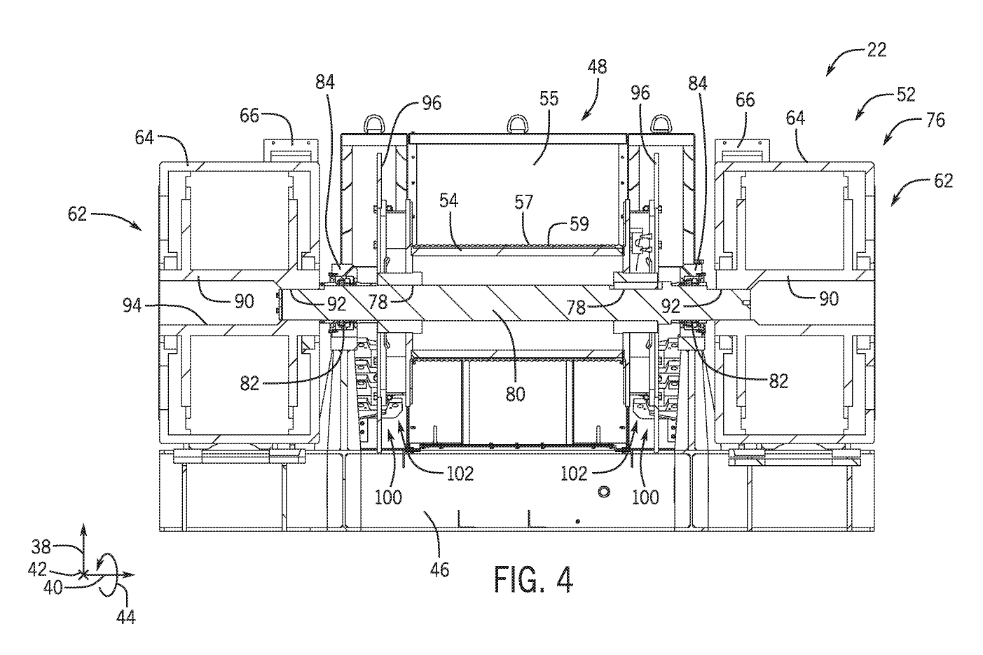

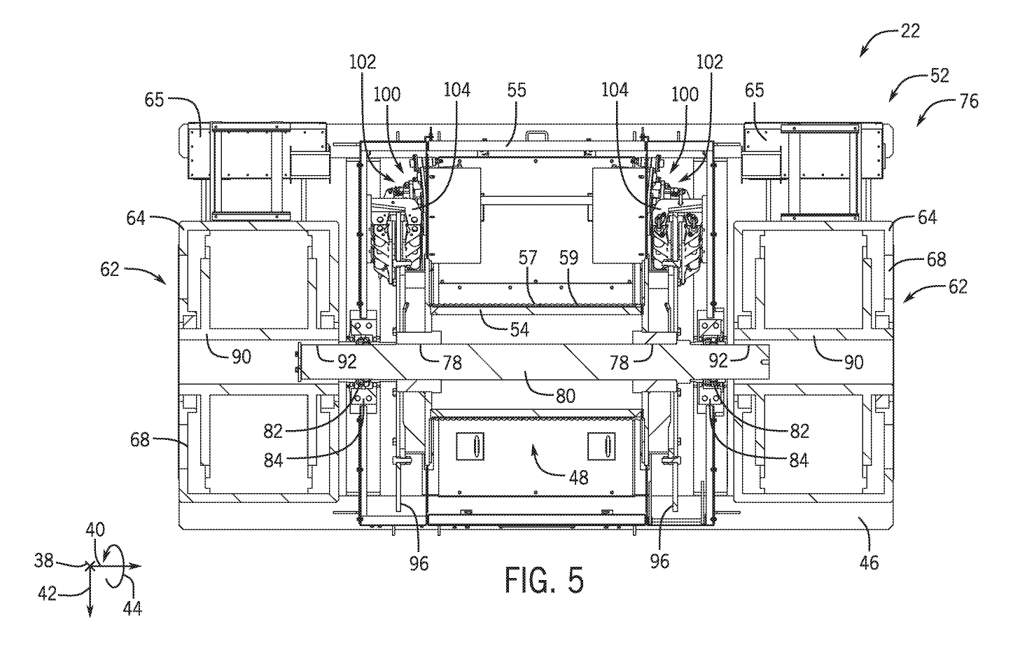

FIG. 4 is a cross-sectional front view and FIG. 5 is a cross-sectional top view of an embodiment of the drawworks system 22. As shown, the drum assembly 48 includes the drum 54 positioned within the drum housing 55, and the drum 54 is mounted on a drum shaft 80 (e.g., non-rotatably mounted via a splined interface 78, such as via one or more male and female splines or mating teeth or grooves, so as to rotate with the drum shaft 80) that extends in the axial direction 40. The drum shaft 80 is rotatably supported above the skid 46 by bearings 82 within bearing housings 84 that are coupled to the skid 46.

In the illustrated embodiment, the drum shaft 80 is coupled (e.g., directly coupled) to respective output shafts 90 (e.g., annular or hollow shafts) of the one or more motors 62, such as via a splined interface 92 (e.g., one or more male and female splines or mating teeth or grooves). In particular, a first end portion of the drum shaft 80 is coupled to a respective output shaft 90 of one motor 62 and a second end portion of the drum shaft 80 is coupled to a respective output shaft 90 of another motor 62. Thus, rotation of the one or more output shafts 90 drives rotation of the drum shaft 80 and the drum 54. Although splined interfaces 78, 92 are shown, it should be appreciated that these interfaces may have any suitable configuration to couple the components to one another, such as a shrink disc coupling, key-slot interface, bushings, stub shaft, one-piece adapter, or the like. In the illustrated embodiment, the drum shaft 80 extends axially into respective openings 94 defined by the output shafts 90 and extends axially into the motor housings 64.

To facilitate braking operations, one or more plates 96 (e.g., annular plates or brake rotors) may extend radially outwardly from the drum shaft 80. For example, in the illustrated embodiment, one plate 96 is positioned on one side of the drum 54, and another plate 96 is positioned on an opposite side of the drum 54 along the axial axis 40 (e.g., the drum 54 is positioned between the two plates 96 along the axial axis 40). The plates 96 may be coupled to the drum shaft 80 or another component of the drum assembly 48 (e.g., via a splined interface, fasteners, or integrally formed), such that the plates 96 rotate with the drum shaft 80. Furthermore, a braking assembly 100 may including one or more brakes 102 (e.g., pneumatic disc brakes or plate brakes) configured to engage the one or more plates 96 to block (e.g., slow or stop) rotation of the drum 54. In the illustrated embodiment, two brakes 102 are provided (e.g., one to engage each plate 96) and are positioned on opposite sides of the drum 54 along the axial axis 40. The one or more brakes 102 may be supported by the skid 46, which may enable the transfer of reaction torque from the one or more brakes 102 to the skid 46. In the illustrated embodiment, the one or more brakes 102 are positioned within the drum housing 55.

More particularly, in some embodiments, the brakes 102 may be fail-safe brakes that are biased (e.g., via one or more biasing members) toward a braked position in which the brakes 102 block rotation the drum shaft 80 unless an air supply (e.g., via a pneumatic system) is provided to overcome the biasing force to hold the brakes 102 in a non-braked position. For example, in certain embodiments, each brake 102 may include a caliper 104. In operation, the air supply may be provided to the brake 102 to overcome the biasing force to separate brake pads supported by the caliper 104 from the radially-extending plate 96, thereby enabling rotation of the drum shaft 80. When the air supply is removed, the biasing force may urge the brake pads into contact with the plate 96, thereby blocking rotation of the drum shaft 80.

In certain embodiments, the one or more brakes 102 may be configured to hold a hoisting load of the drawworks system 22. As discussed above, the one or more brakes 102 may be fail-safe brakes (e.g., spring applied and air released) that are biased toward a braked position and may be held in a non-braked position via an air supply. In certain embodiments, the one or more brakes 102 may be utilized for emergency or parking braking operations (e.g., only for emergency or parking braking operations, non-cyclical braking operations, or holding a suspended load), and the drawworks system 22 is configured to utilize regenerative braking for regular cyclical service braking during hoisting operations. It should be appreciated that the brakes 102 may be any suitable type of brakes, including hydraulically-controlled brakes.

The respective output shafts 90 of the one or more motors 62 may be configured to contact and directly drive the drum shaft 80. The illustrated motors 62 do not include specific internal components as the one or more motors 62 may have any of a variety of configurations to enable the disclosed direct drive operation. For example, each of the motors 62 may be a pseudo direct drive (PDD) motor having integral magnetic gearing (pseudo direct drive [PDD] motors are manufactured by Magnomatics). It should be appreciated that the one or more motors 62 may be alternating current [AC] motors (e.g., having a stator supporting windings and positioned about a rotor supporting a secondary conduction), permanent magnet (PM) motors (e.g., having a stator supporting windings and positioned about a rotor supporting permanent magnets), or any other suitable type of motor.

As noted above, the components of the drawworks system 22 are arranged in a configuration that is compact and that may also facilitate maintenance operations. For example, as shown, the one or more brakes 102 are generally positioned between the drum 54 and the motors 62 along the axial axis 40, are positioned generally rearward of the drum shaft 80 along the lateral axis 42, and are positioned generally vertically below the drum shaft 80 along the vertical axis 38. Furthermore, the motor assembly 52, the brake assembly 100, and the control system may form the drive system 76 that is configured to drive and to block rotation of the drum 54.

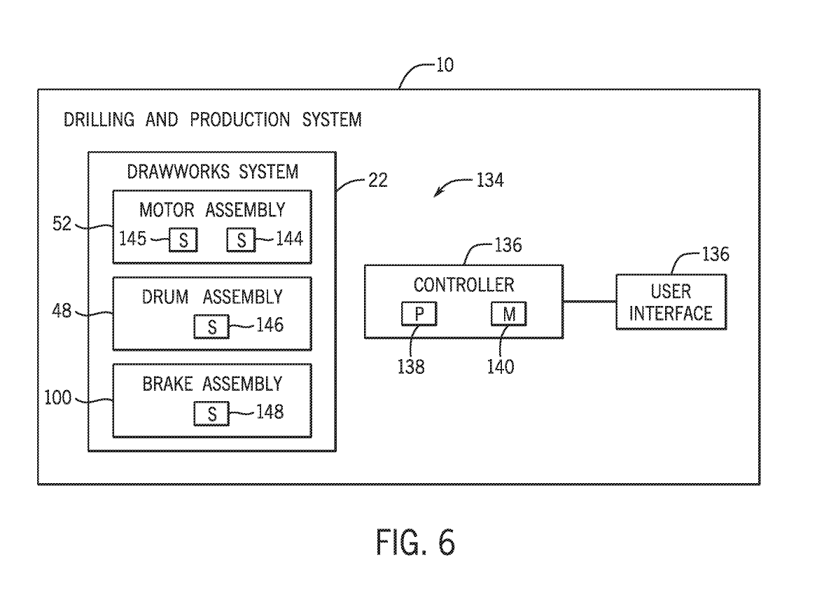

FIG. 6 is a schematic diagram of an embodiment of a control system 134 that may be utilized within the drilling and production system 10 of FIG. 1. As shown, the control system 134 includes a controller 136 (e.g., electronic controller) having a processor 138 and a memory 140. A user interface 142 may be configured to receive an operator input and/or to provide an indication, such as a visual indication on a display and/or an audible indication via a speaker. The control system 134 may include one or more sensors, such as a sensor 144 configured to monitor a speed of a respective motor 62, a sensor 146 configured to monitor a speed of the drum shaft 80, a sensor 148 configured to monitor a temperature within a respective brake 102, or the like. The sensors 144, 146, 148 may provide signals indicative of a condition of the drawworks system 22 to the processor 138 to enable the processor 138 to provide an indication via the user interface 142 and/or to control various components of the drawworks system 22. For example, in some embodiments, the sensor 144 may provide a signal that enables the processor 138 to determine that the motor 62 is not functioning properly (e.g., has failed). In certain embodiments, the processor 138 may provide an audible indication and/or instruct a display to provide a visual indication of the condition of the drawworks system 22 to the operator, thereby enabling or prompting the operator to take appropriate action (e.g., disconnect the motor 62 that has failed from the drum shaft 80). In certain embodiments, upon determination of motor failure, the processor 138 may automatically control one or more valves to adjust (e.g., remove) the air supply that holds the one or more brakes 102 in the non-braked position, thereby causing the one or more brakes 102 to move to the braked position and to block rotation of the drum shaft 80. Indeed, various steps and processes disclosed herein with respect to the hoisting operations may be conducted via operator inputs and/or may be conducted automatically by the processor 138 in response to the condition of the drawworks system 22.

In the illustrated embodiment, the controller 136 includes the processor 138 and the memory 140. The controller 136 may also include one or more storage devices and/or other suitable components. The processor 138 may be used to execute software, such as software for controlling the drawworks system 22. Moreover, the processor 138 may include multiple microprocessors, one or more “general-purpose” microprocessors, one or more special-purpose microprocessors, and/or one or more Application Specific Integrated Circuits (ASIC), or some combination thereof. For example, the processor 138 may include one or more Reduced Instruction Set (RISC) or Complex Instruction Set (CISC) processors. The memory 140 may include a volatile memory, such as Random Access Memory (RAM), and/or a nonvolatile memory, such as Read Only Memory (ROM). The memory 140 may store a variety of information and may be used for various purposes. For example, the memory 140 may store processor-executable instructions (e.g., firmware or software) for the processor 138 to execute, such as instructions for controlling the drawworks system 22, processing signals from the sensors 144, 146, 148, and/or providing indications via the user interface 142. The storage device(s) (e.g., nonvolatile storage) may include read-only memory (ROM), flash memory, a hard drive, or any other suitable optical, magnetic, or solid-state storage medium, or a combination thereof. The storage device(s) may store data (e.g., condition data, thresholds, or the like), instructions (e.g., software or firmware for controlling the drawworks system 22, or the like), and any other suitable data. Although the control system 134 is illustrated with one controller 136 to facilitate discussion, it should be understood that the control system 134 may be a distributed control system having multiple controllers 136 and may be configured to carry out various other functions.

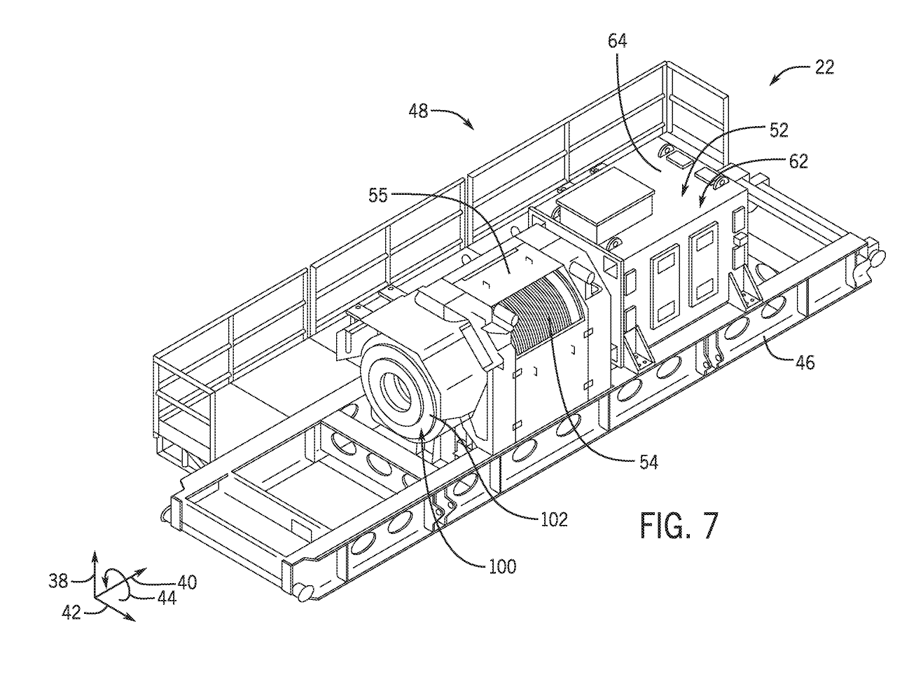

As noted above, the drawworks assembly 22 may include any number of motors 22 having the features disclosed herein, and the drawworks assembly 22 may have various other configurations. For example, FIG. 7 is a perspective front view of a drawworks system 22 having one motor 62 that may be used in the drilling and production system 10 of FIG. 1, in accordance with an embodiment of the present disclosure. As shown, the drawworks system 22 includes the skid 46 that supports the drum assembly 48, the motor assembly 52, and the brake assembly 100. The drum assembly 48 includes the drum 54 mounted on a drum shaft and positioned within or at least partially covered by the drum housing 55. The motor assembly 52 includes one motor 62 (e.g., pseudo direct drive [PDD] motor, alternating current [AC] motor, permanent magnet [PM] motor) supported within the motor housing 64. Furthermore, the brake assembly 100 includes one or more brakes 102 configured to block rotation of the drum 54.

The components of the drawworks system 22 are arranged in a configuration that is compact and that may also facilitate maintenance operations. For example, as shown, the motor 62 is positioned on one side of the drum assembly 48 along the axial axis 40, and the brake 102 is positioned on an opposite side of the drum assembly 48 along the axial axis 40 (e.g., the drum assembly 48 is positioned between the brake 102 and the motor 62 along the axial axis 40). As shown, the motor 62, the drum 54, and the brake 102 are aligned along the axial axis 40 (e.g., coaxial). It should be appreciated that the motor 62 and the brake 102 illustrated in FIG. 7 may have some or all of the features discussed above with respect to FIGS. 2-6, and a control system (e.g., the control system 134) may be utilized to control operation of the drawworks assembly 22 of FIG. 7.

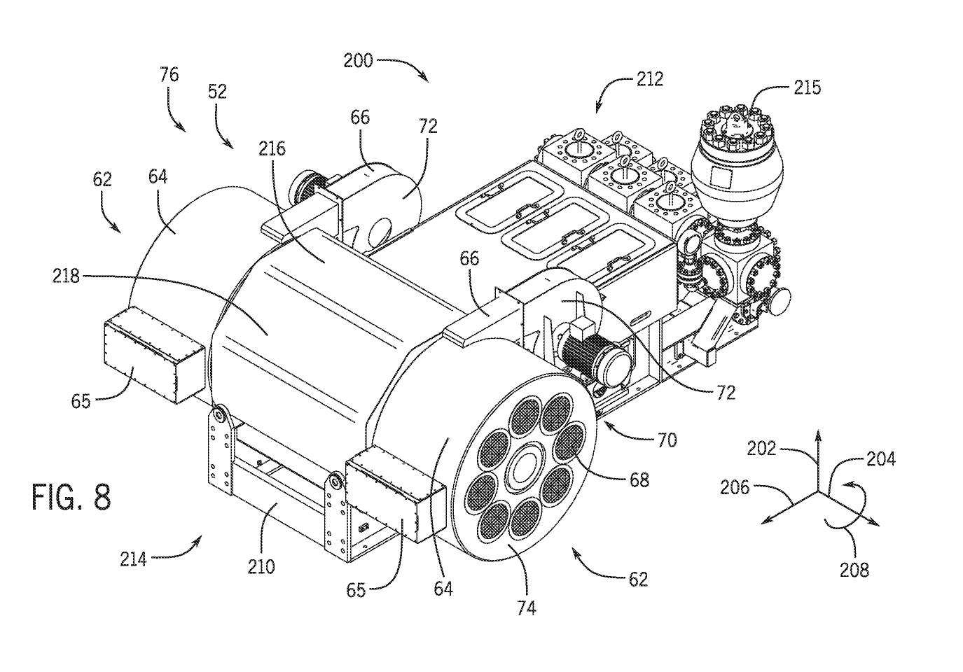

As noted above, the drive system 76 (e.g., the motor assembly 52, the brake assembly 100, and/or other associated components) may be adapted for use with various other types of equipment. Accordingly, FIG. 8 is a perspective front view of a pump system 200 (e.g., mud pump system) that may be used in the drilling and production system 10 of FIG. 1. The pump system 200 may be configured to pump drilling fluid (“mud”) through the drill string 28 (FIG. 1) to a drill bit as the drill bit drills the wellbore 30 (FIG. 1). The pump system 200 may be compact and/or the components may be arranged to facilitate maintenance and/or repair of the pump system 200, for example.

To facilitate discussion, the pump system 200 and its components may be described with reference to a vertical axis or direction 202, the axial axis or direction 204, the lateral axis or direction 206 (or a radial axis or direction), and the circumferential axis or direction 208. In the illustrated embodiment, the drawworks system 22 includes a skid 210 (e.g., frame or support structure) that supports a drum assembly 48 and a motor assembly 52.

The pump system 200 extends between a fluid end portion 212 and a power end portion 214. The fluid end portion 212 may include pistons, valves, and fluid conduits to pump the drilling fluid through the drill string 28 (FIG. 1). As shown, the fluid end portion 212 includes a pulsation dampener 215 that absorbs vibrations to enhance pumping operations. The power end portion 214 may include components of the drive system 76 (e.g., the motor assembly 52), as well as a crankshaft assembly 216 that includes a crankshaft that is driven by the drive system 76 and that coverts rotation into the reciprocating motion of the pistons.

The motor assembly 52 may include one or more electric motors 62 (e.g., pseudo direct drive [PDD] motors manufactured by Magnomatics, alternating current [AC] motors, permanent magnet [PM] motors) supported within respective motor housings 64. The motor housings 64 may be coupled to a crankshaft housing 218 via one or more fasteners (e.g., bolts). The motor assembly 52 may also include one or more junction boxes 65 that support circuitry to power or control operation of the one or more motors 62, one or more air intake assemblies 66 that provide air to the one or more motors 62, and one or more exhaust ports 68 that exhaust air from the one or more motors 62. More particularly, each motor 62 may be coupled to a respective junction box 65 that includes circuitry to power or control operation of the motor 62. Furthermore, each motor 62 may be coupled to a respective air intake assembly 66 of the one or more air intake assemblies 66, and each of the one or more air intake assemblies 66 may include an inlet 70 and a fan 72 (e.g., blower) configured to draw air through the inlet 70 and force air into the motor 62. Each motor 62 may also include one or more exhaust ports 68, which may be formed in the motor housing 64. As shown, multiple exhaust ports 68 are arranged circumferentially about an axially-facing end surface 74 of the motor housing 64. The illustrated position of the exhaust ports 68 and the air intake assembly 68 may facilitate cooling (e.g., the hot air exhausted through the exhaust ports 68 may be directed generally away from the air inlet 70).

The illustrated embodiment includes two motors 62; however, it should be understood that any suitable number (e.g., 1, 2, 3, 4, or more) of motors 62 may be provided. As discussed in more detail below, respective output shafts extending from the one or more motors 62 of the motor assembly 52 may be coupled (e.g., directly coupled via a splined interface, shrink disc coupling, key-slot interface, bushings, stub shaft, one-piece adapter) to respective ends of a crankshaft of the pump system 200.

In embodiment having multiple motors 62, the multiple motors 62 may enable the pump system 200 to pump the drilling fluid using less than all of the motors 62 (e.g., upon failure of one of the two motors 62 shown in FIG. 8). For example, during normal operation of the pump system 200, both of the motors 62 may drive rotation of the crankshaft. However, upon certain circumstances (e.g., if a first motor 62 fails), one motor 62 (e.g., the first motor 62) may be disconnected from the crankshaft and another motor 62 (e.g., a second motor 62) may operate to enable the pump system 200 to pump the drilling fluid using only the second motor 62.

The components of the pump system 200 are arranged in a configuration that is compact and that may also facilitate maintenance operations. For example, as shown, the motor assemblies 62 are positioned on opposite sides of the crankshaft assembly 216 along the axial axis 204 (e.g., the crankshaft assembly 216 is positioned between the two motor assemblies 62 along the axial axis 204). Furthermore, each air inlet 70 of the respective air inlet assembly 66 is positioned rearward of the respective motor housing 64 along the radial axis 206, and each junction box 65 is positioned forward of the respective motor housing 64 along the radial axis 206 (e.g., the motor housing 64 is positioned between the air inlet 70 and the junction box 65 along the radial axis 206). In the illustrated embodiment, the exhaust ports 68 are formed in the axially-facing end surface 74 of the motor housing 64. Thus, for each motor 62, the crankshaft assembly 216 is positioned one side of the motor 62, and the exhaust ports 68 are positioned on an opposite side of the motor 62 along the axial axis 204 (e.g., the motor 62 is positioned between the crankshaft assembly 216 and the exhaust ports 68 formed in the axially-facing end surface 74 of the motor housing 64 along the axial axis 204). Furthermore, in the illustrated embodiment, each junction box 65 and each air intake assembly 66 do not extend beyond the respective motor housing 64 along the axial axis 204 (e.g., an entirety of the junction box 65 and an entirety of the air intake assembly 66 are positioned between the crankshaft housing 218 and the axially-facing end surface 74 of the respective motor housing 64 along the axial axis 204).

As discussed in more detail below, the pump system 200 may include or be coupled to a control system (e.g., an electronic control system having an electronic controller having a processor and a memory) that is configured to receive and to process data from various sensors positioned about the pump system 200 (e.g., a speed sensor coupled to the motor 62, a speed sensor coupled to the crankshaft), to receive control signals and/or operator inputs, to provide an indication (e.g., a visual indication via a display and/or an audible indication via a speaker) of a condition of the pump system 200 (e.g., failure of the motor 62) to an operator, and/or to control components of the pump system 200 (e.g., operate the one or more motors 62) based on the data and/or the operator inputs, for example. In certain embodiments, the drawworks system 22 disclosed herein may utilize gaseous fluid (e.g., air or inert gas, such as nitrogen) in operation (e.g., to cool the motors 62), and may not utilize liquid fluid (e.g., water) in operation. It should also be appreciated that the motor assembly 52 and the control system may have some or all of the features disclosed above with respect to FIGS. 1-7, and furthermore, that the brake assembly 100 (FIGS. 4 and 5) may be utilized as part of the pump system 200.

Advantageously, the disclosed pump system 200 may be devoid of a transmission (e.g., gearbox having mechanical gears, such as spur gears or the like). For example, the pump system 200 does not include a transmission between the one or more motors 62 and the crankshaft to adjust a power output of the one or more motors 62 to drive the crankshaft. Thus, the pump system 200 does not utilize pressurized oil for lubrication of gears, bearings, or the like. Thus, the pump system 200 includes a relatively low number of components (e.g., compared to other pump systems), which may reduce cost, size, weight, and/or facilitate maintenance operations. Furthermore, the pump system 200 is a low-inertia system, and thus, the pump system 200 may utilize less energy during pumping operations.

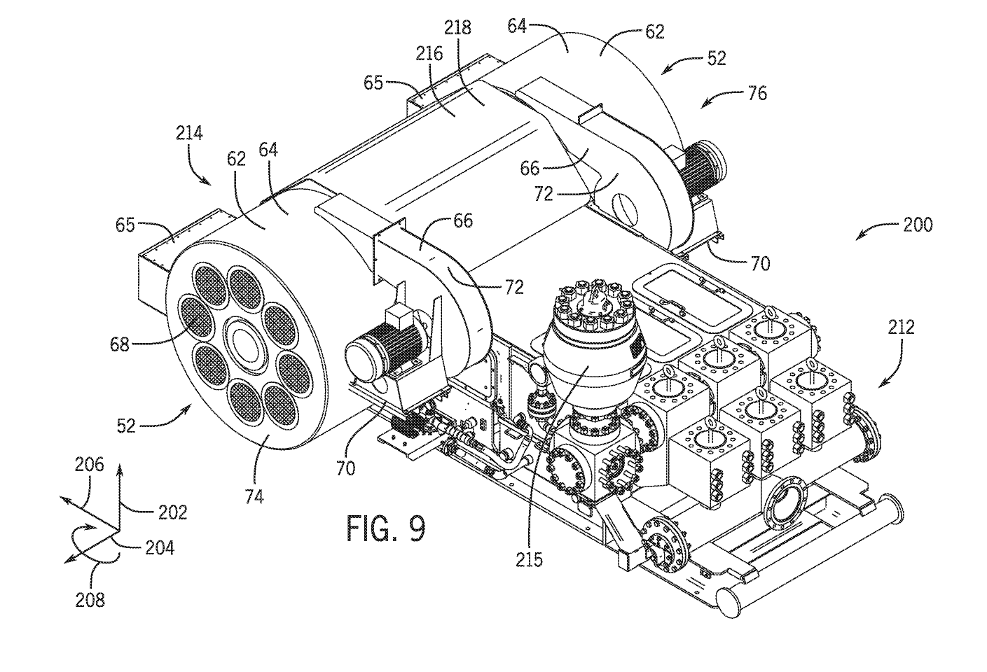

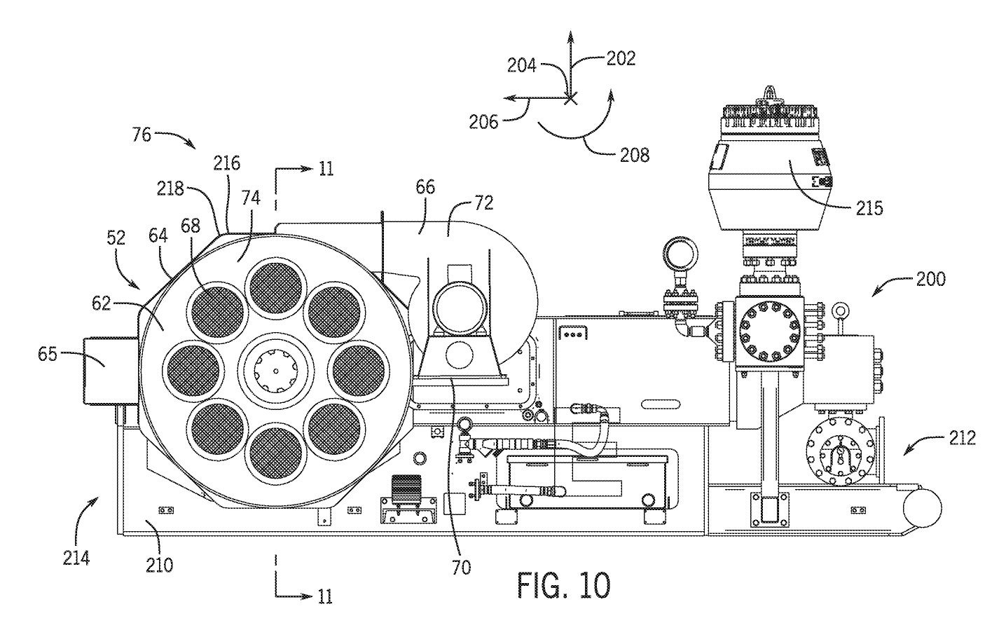

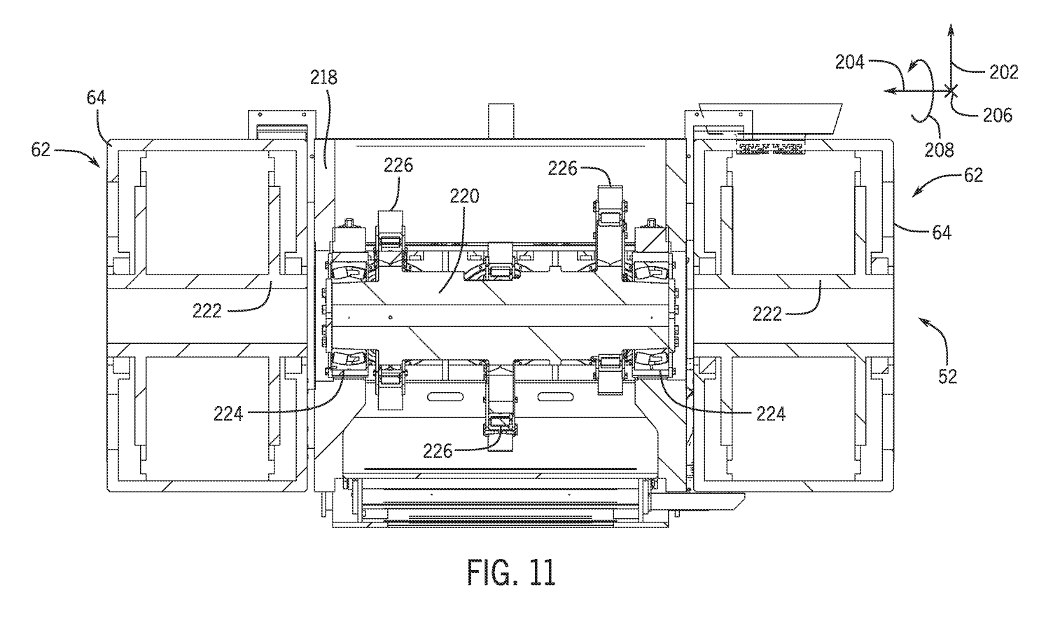

FIGS. 9-11 show alternate views of the pump system 200. In particular, FIG. 9 is a perspective rear view of the pump system 200, FIG. 10 is a side view of the pump system 200, and FIG. 11 is a front cross-sectional view of the pump system 200 taken through line 11-11 in FIG. 10. FIGS. 9 and 10 generally illustrate the components shown and described with respect to FIG. 8.

FIG. 11 also illustrates a crankshaft 220 that is positioned within the crankshaft housing 218. As shown, the crankshaft 220 is coupled (e.g., directly coupled to respective output shafts 222 (e.g., annular or hollow shafts) of the one or more motors 62 (e.g., non-rotatably coupled via a splined interface, such as via one or more male and female splines or mating teeth or groove). Thus, rotation of the one or more output shafts 222 drives rotation of the crankshaft 220. It should be appreciated that the interfaces between the crankshaft 220 and the output shafts 222 may have any suitable configuration to couple the components to one another, such as a shrink disc coupling, key-slot interface, bushings, stub shaft, one-piece adapter, or the like. The crankshaft 220 is rotatably supported above the skid 210 by bearings 224. The crankshaft 220 includes one or more connecting rod journals 226 that each couple to a respective connecting rod and piston. The crankshaft 220 is driven to rotate by the output shafts 222, and the rotation of the crankshaft 220 drives the connecting rods and pistons to move in a reciprocating manner to pump drilling fluid into the drilling riser.

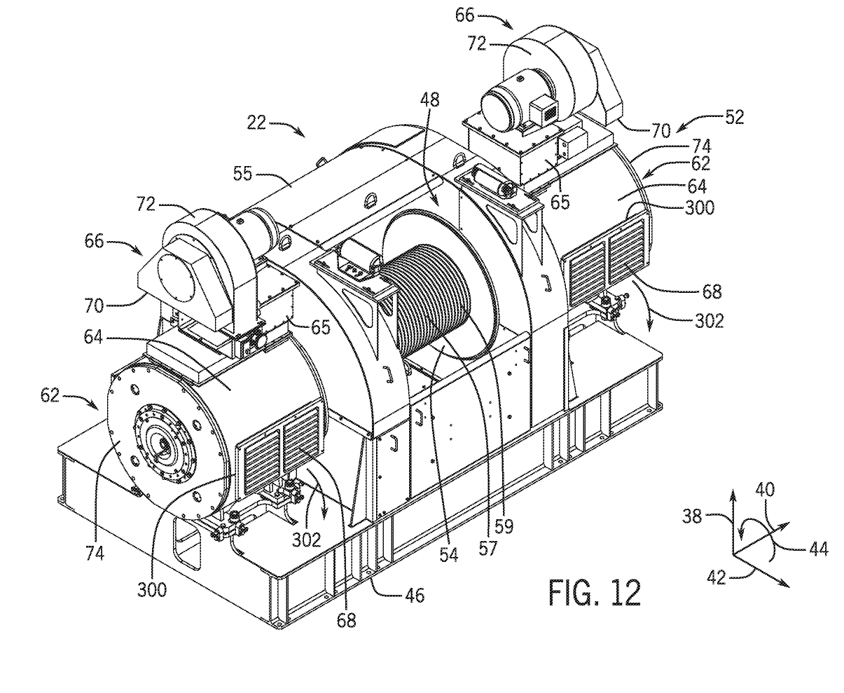

FIGS. 12-17 illustrate various views of an embodiment of another drawworks system 22 that may be used in the drilling and production system of FIG. 1. While FIGS. 1-5 illustrate one embodiment of the drawworks system 22 and FIGS. 12-17 illustrate another embodiment of the drawworks system 22 to facilitate discussion, it is envisioned that the features described with respect to FIGS. 1-5 and FIGS. 12-17 may be combined in any of a variety of ways to create a compact and/or easily maintained drawworks system 22. Furthermore, it should be appreciated that the drawworks system 22 of FIGS. 12-17 may be controlled by the control system 134 of FIG. 6 and/or may be modified to include one motor similar to the drawworks system 22 of FIG. 7.

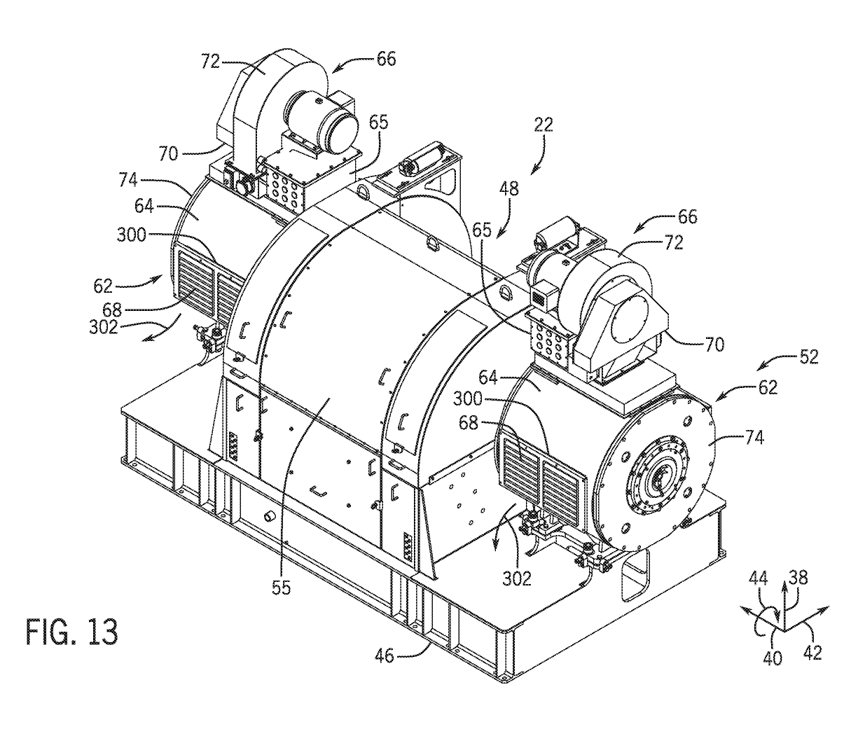

With the foregoing in mind, FIG. 12 is a perspective front view and FIG. 13 is a perspective rear view of the drawworks system 22. The drawworks system 22 and its components may be described with reference to the vertical axis or direction 38, the axial axis or direction 40, the lateral axis or direction 42 (or the radial axis or direction), and the circumferential axis or direction 44. In the illustrated embodiment, the drawworks system 22 includes the skid 46 that supports the drum assembly 48 and the motor assembly 52.

The drum assembly 48 includes the drum 54 mounted on a drum shaft and positioned within or at least partially covered by the drum housing 55. As shown, the outer surface 57 of the drum 54 includes grooves 59 that are configured to support a cable (e.g., the cable 24) that is wrapped circumferentially about the drum 54.

The motor assembly 52 may include one or more electric motors 62. In the illustrated embodiment, the motor assembly 52 includes two AC motors 62 supported within respective motor housings 64, although any of a variety of motors may be utilized. The motor housings 64 may be coupled to opposite axial sides of the drum housing 55 via one or more fasteners (e.g., bolts). The motor assembly 52 may also include one or more junction boxes 65 that support circuitry to power or control operation of the one or more motors 62, one or more air intake assemblies 66 that provide air to the one or more motors 62, and one or more exhaust ports 68 (e.g., vents) that exhaust air from the one or more motors 62. More particularly, each motor 62 may be coupled to a respective junction box 65 that includes circuitry to power or control operation of the motor 62. Furthermore, each motor 62 may be coupled to a respective air intake assembly 66 of the one or more air intake assemblies 66, and each of the one or more air intake assemblies 66 may include an inlet 70 and a fan 72 (e.g., blower) configured to draw air through the inlet 70 and force air into the motor 62. Each motor 62 may also include one or more exhaust ports 68, which may be formed in the motor housing 64. As shown, multiple exhaust ports 68 are arranged as vents (e.g., laterally-extending vents) formed on a laterally-facing surface 300 (e.g., forward-facing surface and/or rearward-facing surface) of the motor housing 64. The illustrated position and configuration of the exhaust ports 68 and the air intake assembly 66 may facilitate cooling (e.g., the hot air exhausted through the exhaust ports 68 may be directed in a generally lateral and/or downward direction, as shown by arrow 302, and/or generally away from the air inlet 70).

As discussed in more detail below, respective output shafts extending from the one or more motors 62 of the motor assembly 52 may be coupled (e.g., directly coupled via a splined interface, shrink disc coupling, key-slot interface, bushings, stub shaft, one-piece adapter) to respective ends of the drive shaft of the drum assembly 48. In embodiment having multiple motors 62, the multiple motors 62 may enable the drawworks system 22 to hoist the load using less than all of the motors 62 (e.g., upon failure of one of the two motors 62 shown in FIG. 2).

The components of the drawworks system 22 are arranged in a configuration that is compact and that may also facilitate maintenance operations. For example, as shown, the motor assemblies 62 are positioned on opposite sides of the drum assembly 58 along the axial axis 40 (e.g., the drum assembly 58 is positioned between the two motor assemblies 62 along the axial axis 40). Furthermore, each air inlet 70 of the respective air inlet assembly 66 is positioned vertically above the respective motor housing 64 along the vertical axis 38, and each junction box 65 is positioned vertically between the respective motor housing 64 and a portion of the respective fan 72 (e.g., a motor housing of the fan 72) along the vertical axis 38 and also between the respective air inlet 70 and the drum housing 55 along the axial axis 40.

In the illustrated embodiment, the exhaust ports 68 are formed in the laterally-facing surface 300 of the motor housing 64. Furthermore, in the illustrated embodiment, each junction box 65 and each air intake assembly 66 do not extend beyond the respective motor housing 64 along the axial axis 40 (e.g., an entirety of the junction box 65 and an entirety of the air intake assembly 66 are positioned between the drum housing 55 and the axially-facing end surface 74 of the respective motor housing 64 along the axial axis 40). Each air intake assembly 66 may also be positioned so as not to extend laterally beyond the respective motor housing 64 along the lateral axis 42.

Advantageously, the drawworks system 22 may be devoid of a transmission (e.g., gearbox having mechanical gears, such as spur gears or the like). For example, the drawworks system 22 does not include a transmission between the one or more motors 62 and the drum shaft to adjust a power output of the one or more motors 62 to drive the drum shaft. Thus, the drawworks system 22 does not adjust the power output of the one or more motors 62 to drive the drum shaft, and the drawworks system 22 does not utilize pressurized oil for lubrication of gears, bearings, or the like. Thus, the drawworks system 22 includes a relatively low number of components, which may reduce cost, size, weight, and/or facilitate maintenance operations. Furthermore, the illustrated drawworks system 22 is a low-inertia system, and thus, the drawworks system 22 may utilize less energy during hoisting, lowering, and braking operations. The low inertia may also provide faster tripping (e.g., hoisting and lowering) times due to quicker acceleration and more time at peak block speed (e.g., speed of the traveling block 20).

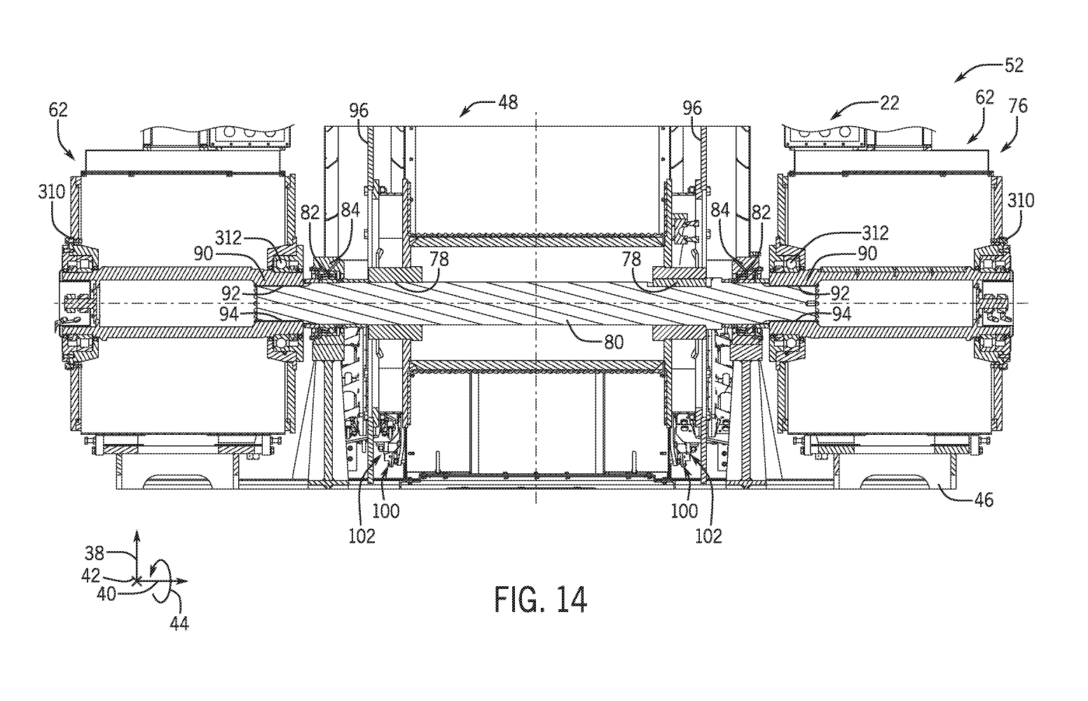

FIG. 14 is a cross-sectional front view of an embodiment of the drawworks system 22 of FIGS. 12 and 13. As shown, the drum assembly 48 includes the drum 54 positioned within the drum housing 55, and the drum 54 is mounted on the drum shaft 80 (e.g., non-rotatably mounted via the splined interface 78, such as via one or more male and female splines or mating teeth or grooves, so as to rotate with the drum shaft 80) that extends in the axial direction 40. The drum shaft 80 is rotatably supported above the skid 46 by bearings 82 within bearing housings 84 that are coupled to the skid 46.

In the illustrated embodiment, the drum shaft 80 is coupled (e.g., directly coupled) to respective output shafts 90 (e.g., annular or hollow shafts) of the one or more motors 62, such as via the splined interface 92 (e.g., one or more male and female splines or mating teeth or grooves). Thus, rotation of the one or more output shafts 90 drives rotation of the drum shaft 80 and the drum 54. In certain embodiments, a surface treatment (e.g., nitriding) may be provided at the interface 92. Although splined interfaces 78, 92 are shown, it should be appreciated that these interfaces may have any suitable configuration to couple the components to one another, such as a shrink disc coupling, key-slot interface, bushings, stub shaft, one-piece adapter, or the like. In the illustrated embodiment, the drum shaft 80 extends axially into the opening 94 defined by the output shaft 90 and extends axially into the motor housing 64.

To facilitate braking operations, one or more plates 96 (e.g., annular plates or brake rotors) may extend radially outwardly from the drum shaft 80. For example, in the illustrated embodiment, one plate 96 is positioned on one side of the drum 54, and another plate 96 is positioned on an opposite side of the drum 54 along the axial axis 40 (e.g., the drum 54 is positioned between the two plates 96 along the axial axis 40). The plates 96 may be coupled to the drum shaft 80 or another component of the drum assembly 48 (e.g., via a splined interface, fasteners, or integrally formed), such that the plates 96 rotate with the drum shaft 80. Furthermore, the braking assembly 100 may including one or more brakes 102 (e.g., pneumatic disc brakes or plate brakes) configured to engage the one or more plates 96 to block (e.g., slow or stop) rotation of the drum 54. In the illustrated embodiment, two brakes 102 are provided (e.g., one for each plate 96, and thus, two brakes are positioned on opposite sides of the drum 54 along the axial axis 40. The one or more brakes 102 may be supported by the skid 46, which may enable the transfer of reaction torque from the one or more brakes 102 to the skid 46. In the illustrated embodiment, the one or more brakes 102 are positioned within the drum housing 55.

As noted above, the brakes 102 may be fail-safe brakes that are biased (e.g., via one or more biasing members) toward a braked position in which the brakes 102 block rotation the drum shaft 80 unless an air supply (e.g., via a pneumatic system) is provided to overcome the biasing force to hold the brakes 102 in a non-braked position. In certain embodiments, the one or more brakes 102 may be configured to hold a hoisting load of the drawworks system 22. The one or more brakes 102 may be utilized for emergency or parking braking operations, and the drawworks system 22 is configured to utilize regenerative braking for regular cyclical service braking during hoisting operations. It should be appreciated that the brakes 102 may be any suitable type of brakes, including hydraulically-controlled brakes.

The respective output shafts 90 of the one or more motors 62 may be configured to contact and directly drive the drum shaft 80. The illustrated motors 62 do not include specific internal components as the one or more motors 62 may have any of a variety of configurations to enable the disclosed direct drive operation. For example, each of the motors 62 may be AC motors or any other suitable type of motor.

As noted above, the components of the drawworks system 22 are arranged in a configuration that is compact and that may also facilitate maintenance operations. For example, as shown, the one or more brakes 102 are generally positioned between the drum 54 and the motor 62 along the axial axis 40, are positioned generally rearward of the drum shaft 80 along the lateral axis 42, and are positioned generally vertically below the drum shaft 80 along the vertical axis 38. Furthermore, the motor assembly 52, the brake assembly 100, and the control system may form the drive system 76 that is configured to drive and to block rotation of the drum 54.

In certain embodiments, a ceramic element 310 (e.g., aluminum oxide coating or space) is provided between a rotor of the each motor 62 and the motor housing 64. The ceramic element 310 may provide electrical insulation of a rotor from a stator of each motor 62 to block circulating current and/or to facilitate transfer of a load from the drum 54 to the motor housing 64, for example. Additionally, the drawworks system 22 includes motor bearings 312 that support respective output shafts 90 within respective motor housings 64. The illustrated embodiment includes two motor bearings 312 positioned on opposite sides of the drum shaft 80 along the axial axis 40. Such a configuration may advantageously enable the motor bearings 312 to also support the drum shaft 80 and/or a load (e.g., hoisting load), such as upon failure of the bearings 84 or at any other time during hoisting operations.

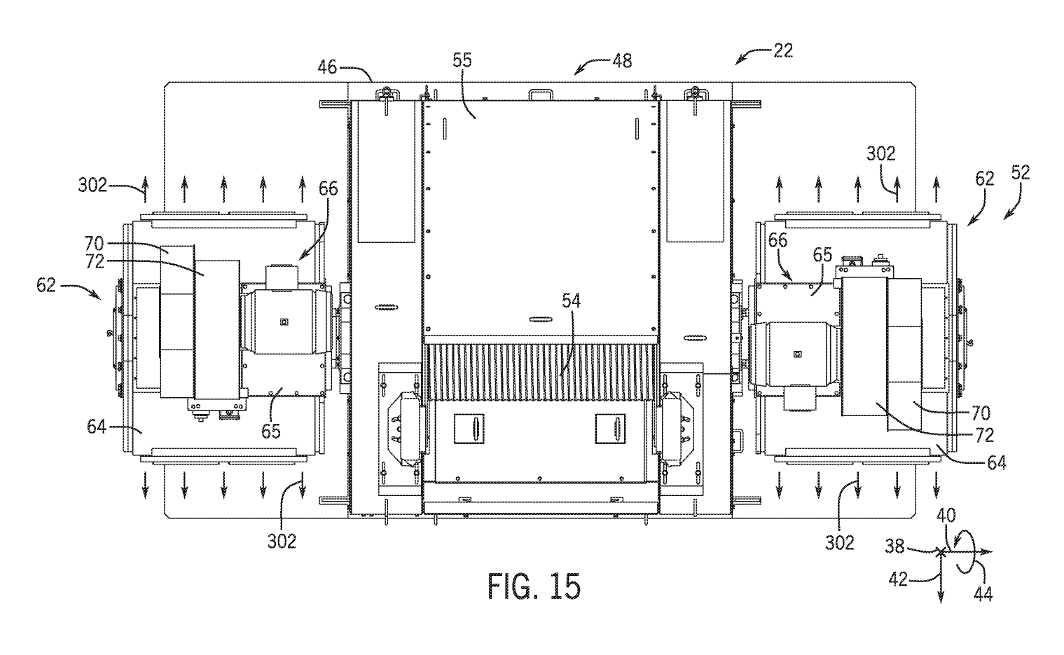

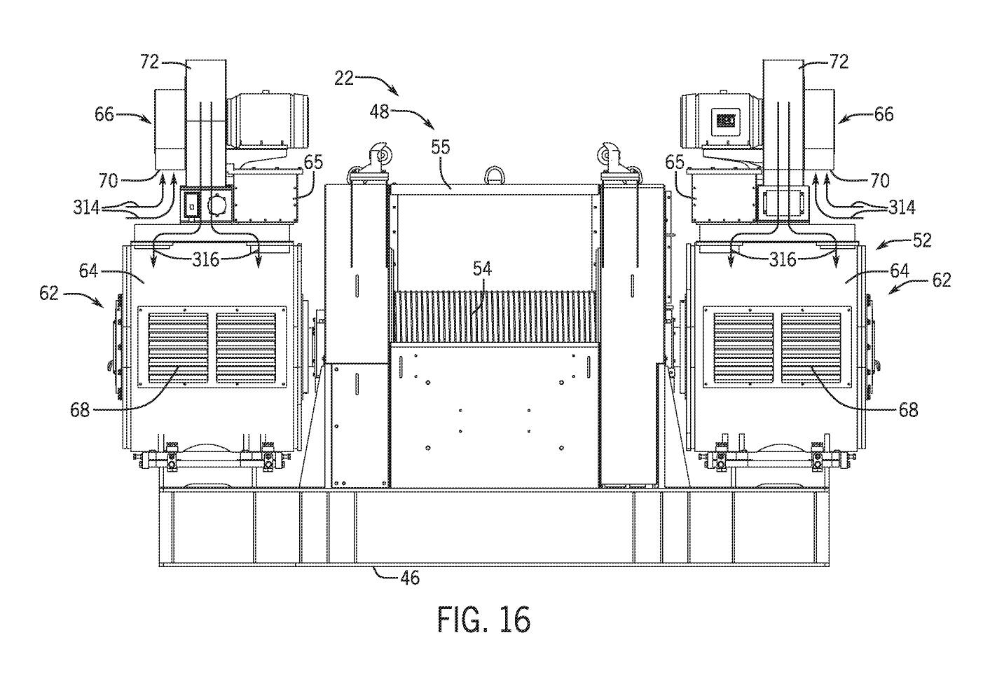

FIG. 15 is a top view and FIG. 16 is a front view of the drawworks system 22 of FIGS. 12-14. As shown, the drawworks system 22 is supported on the skid 46 and includes the drum assembly 48 having the drum 54, the motor assembly 52 having the motors 62 within the motor housings 64, the air assemblies 66 having the air inlets 70 and the fans 72, the junction box 65, and the exhaust ports 68. FIGS. 15 and 16 also illustrate an example air flow through the motor housings 64. For example, air may be drawn through the air inlets 70, as shown by arrow 314, then directed into the motor housings 64, as shown by arrow 316, and then exhausted out of the motor housings 64, as shown by arrow 302.

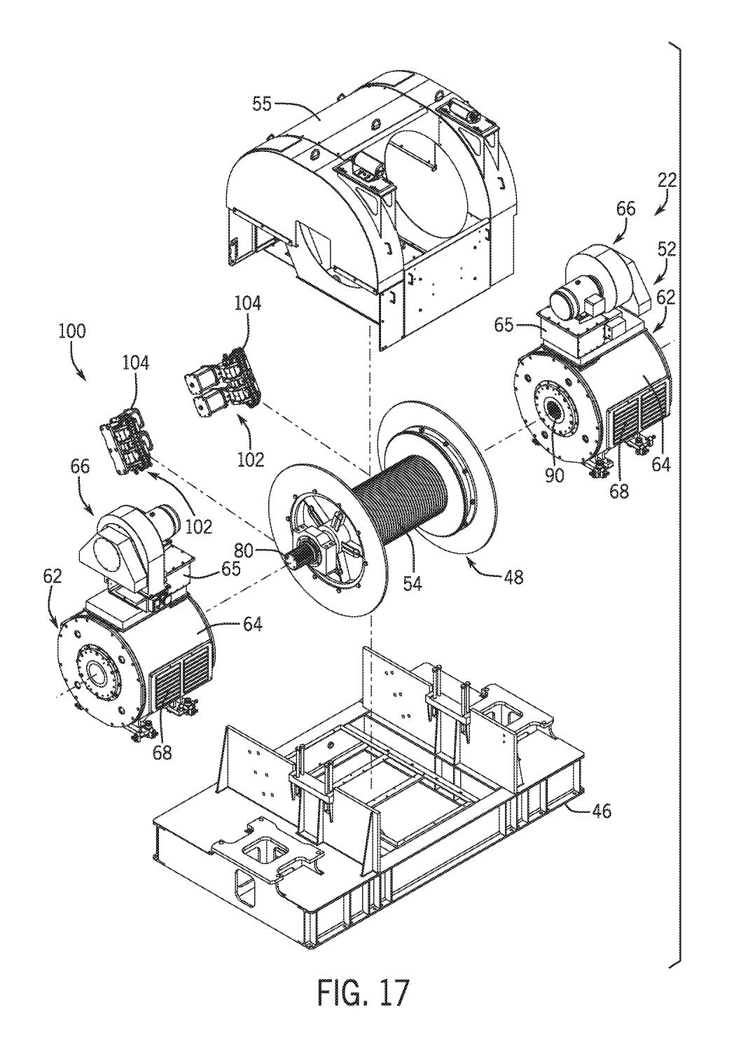

FIG. 17 is an exploded perspective front view of the drawworks system of FIGS. 12-16. As shown, the drawworks system 22 is supported on the skid 46 and includes the drum assembly 48 having the drum 54, the motor assembly 52 having the motors 62 within the motor housings 64, the brake assembly 100 having the brakes 102 (e.g., calipers 104), the air assemblies 66, the junction box 65, and the exhaust ports 68. FIG. 17 also illustrates the drum shaft 80 and the output shaft 90 of the motors 62 that enable the output shaft 90 to drive (e.g., directly drive) rotation of the drum shaft 80.

The illustrated motors 62 do not include specific internal components as the one or more motors 62 may have any of a variety of configurations to enable the disclosed direct drive operation. For example, each of the motors 62 may be a pseudo direct drive (PDD) motor having integral magnetic gearing (pseudo direct drive [PDD] motors are manufactured by Magnomatics). It should be appreciated that the one or more motors 62 may be alternating current [AC] motors (e.g., having a stator supporting windings and positioned about a rotor supporting a secondary conduction), permanent magnet (PM) motors (e.g., having a stator supporting windings and positioned about a rotor supporting permanent magnets), or any other suitable type of motor.

The drawworks system 22 and the pump system 200 are merely exemplary, and it should be appreciated that various combinations and arrangements of the features shown and described with respect to FIGS. 1-17 are envisioned. Furthermore, the control system 134 of FIG. 6 may be utilized to monitor and control the pump system 200. For example, one or more sensors may monitor one or more characteristics related to the pump system 200, and the controller may provide control signals to provide indications or to control components of the pump system 200.

While the disclosure may be susceptible to various modifications and alternative forms, specific embodiments have been shown by way of example in the drawings and have been described in detail herein. However, it should be understood that the disclosure is not intended to be limited to the particular forms disclosed. Rather, the disclosure is to cover all modifications, equivalents, and alternatives falling within the spirit and scope of the disclosure as defined by the following appended claims. Furthermore, any of the features and components of FIGS. 1-8 may be utilized together and/or combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system for a mineral extraction system, comprising:
a shaft rotatably supported above a platform;
a first motor comprising a first output shaft that is coupled to a first end portion of the shaft to drive rotation of the shaft; and
a second motor comprising a second output shaft that is coupled to a second end portion of the shaft to drive rotation of the shaft;
wherein the system is devoid of a transmission between the first motor and the shaft.

2. The system of claim 1, wherein the system is devoid of a transmission between the second motor and the shaft.

3. The system of claim 1, wherein the first motor comprises a pseudo direct drive motor, a permanent magnet motor, or an alternating current motor.

4. The system of claim 1, comprising a brake assembly configured to block rotation of the shaft.

5. The system of claim 4, wherein the brake assembly comprises one or more disc brakes.

6. The system of claim 4, comprising a first plate and a second plate coupled to the shaft, wherein the brake assembly comprises a first caliper configured to engage the first plate to block rotation of the shaft and a second caliper configured to engage the second plate to block rotation of the shaft.

7. The system of claim 6, wherein the first caliper and the second caliper are positioned rearward of the shaft along a lateral axis of the system and vertically below the shaft along a vertical axis of the system.

8. The system of claim 1, wherein the first output shaft is coupled to the shaft via a splined interface.

9. The system of claim 1, comprising a motor housing that surrounds the first motor, wherein the shaft extends axially into the motor housing, and the first end of the shaft is supported within an opening defined by the first output shaft.

10. The system of claim 9, comprising a motor bearing within the motor housing, wherein the motor bearing is configured to support at least a portion of a load applied to the shaft.

11. The system of claim 1, wherein the shaft comprises a drum shaft coupled to a drum configured to support a cable.

12. The system of claim 1, wherein the shaft comprises a crankshaft configured to couple to one or more pistons to facilitate pumping a drilling fluid into a drilling riser.

13. A system for a mineral extraction system, comprising:
a shaft extending from a first end to a second end;
a first motor housing supporting a first motor, wherein the first motor comprises a first output shaft that is coaxial with the shaft and is coupled to the first end portion of the shaft to drive rotation of the shaft;
a second motor housing supporting a second motor, wherein the second motor comprises a second output shaft that is coaxial with the shaft and is coupled to the second end portion of the shaft to drive rotation of the shaft; and
a brake assembly comprising a first caliper configured to engage a first plate coupled to the shaft to block rotation of the shaft and a second caliper configured to engage a second plate coupled to the shaft to block rotation of the shaft.

14. The system of claim 13, wherein the system is devoid of a transmission.

15. The system of claim 13, wherein the first motor comprises a pseudo direct drive motor, a permanent magnet motor, or an alternating current motor.

16. The system of claim 13, wherein the first caliper and the second caliper are positioned rearward of the shaft along a lateral axis of the system and vertically below the shaft along a vertical axis of the system.

17. The system of claim 13, wherein the shaft comprises a drum shaft coupled to a drum configured to support a cable.

18. The system of claim 13, wherein the shaft comprises a crankshaft configured to couple to one or more pistons to facilitate pumping a drilling fluid into a drilling riser.

19. A system for a mineral extraction system, comprising:
a shaft rotatably supported on a platform; and
a first motor housing supporting a first motor, wherein the first motor comprises a first output shaft that is coaxial with the shaft and is coupled to a first end portion of the shaft to drive rotation of the shaft, the shaft extends axially into the first motor housing, the first end portion of the shaft is supported within an opening defined by the first output shaft, and the system is devoid of a transmission between the first motor and the shaft.

20. The system of claim 19, comprising a second motor housing supporting a second motor, wherein the second motor comprises a second output shaft that is coaxial with the shaft and is coupled to a second end portion of the shaft to drive rotation of the shaft.
